(19) United States
(12) Patent Application Publication
(10) Pub. No.: US 2011/0261478 A1
(43) Pub. Date: Oct. 27, 2011

(54) MAGNETORESISTIVE ELEMENT AND MAGNETIC RECORDING APPARATUS

(75) Inventors: Akihiko Takeo, Kunitachi-shi (JP); Yoshihiko Fuji, Kawasaki-shi (JP); Hiromi Yuasa, Kawasaki-shi (JP); Michiko Hara, Yokohama-shi (JP); Shuichi Murakami, Tokyo (JP); Hideaki Fukuzawa, Kawasaki-shi (JP)

(73) Assignee: KABUSHIKI KAISHA TOSHIBA, Tokyo (JP)

(21) Appl. No.: 13/092,044

(22) Filed: Apr. 21, 2011

(30) Foreign Application Priority Data
Apr. 21, 2010 (JP) 2010-098191

(51) Int. Cl. G11B 5/02; G11B 5/39

(52) U.S. Cl. 360/55; 428/811.1; G9B/5.026

(57) ABSTRACT

According to one embodiment, a magnetoresistive element includes a stack and a pair of electrodes that allows electric current to flow through the stack in a direction perpendicular to a surface of the stack. The stack includes a cap layer, a magnetization pinned layer, a magnetization free layer provided between the cap layer and the magnetization pinned layer, a tunneling insulator provided between the magnetization pinned layer and the magnetization free layer, and a functional layer provided within the magnetization pinned layer, between the magnetization pinned layer and the tunneling insulator, between the tunneling insulator and the magnetization free layer, within the magnetization free layer, or between the magnetization free layer and the cap layer. The functional layer includes an oxide including at least one element selected from Zn, In, Sn and Cd and at least one element selected from Fe, Co and Ni.

### CROSS-REFERENCE TO RELATED APPLICATIONS

This application is based upon and claims the benefit of priority from Japanese Patent Application No. 2010-098191, filed Apr. 21, 2010; the entire contents of which are incorporated herein by reference.

### FIELD

Embodiments described herein relate generally to a magnetoresistive element and a magnetic recording apparatus including the same.

### BACKGROUND

Improvement of the quality of a magnetoresistive (MR) element requires the increase of the MR ratio. For the purpose of increasing the MR ratio, modification of the structure of magnetoresistive elements and selection of the spacer layer materials have been carried out. For example, a magnetoresistive element including a thin spin-filter (SF) layer made of an oxide or nitride within each ferromagnetic layer or between the ferromagnetic layer and a non-magnetic spacer layer is proposed. The SF layer has a spin-filter effect of inhibiting the passage of upspin or downspin electrons, and thus increases the MR ratio. Thus, magnetoresistive elements have undergone many improvements, but are required to achieve further increase of the MR ratio.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of a magnetoresistive element according to a first embodiment;

FIG. 2 is a perspective view of a magnetoresistive element according to a first modification;

FIG. 3 is a perspective view of a magnetoresistive element according to a second modification;

FIG. 4 is a perspective view of a magnetoresistive element according to a third modification;

FIG. 5 is a perspective view of a magnetoresistive element according to a fourth modification;

FIG. 6 is a perspective view of a magnetoresistive element according to a fifth modification;

FIG. 7 is a perspective view of a magnetoresistive element according to a sixth modification;

FIG. 8 is a cross-sectional view of a magnetic head according to a second embodiment;

FIG. 9 is a cross-sectional view of a magnetic head according to the second embodiment;

FIG. 10 is an exploded perspective view of a magnetic recording apparatus according to a third embodiment;

FIG. 11 is a perspective view of a head slider;

FIG. 12A is a perspective view of a head stack assembly; and

FIG. 12B is an exploded perspective view of a head gimbal assembly.

### DETAILED DESCRIPTION

Various embodiments will be described hereinafter with reference to the accompanying drawings. In the drawings described below, reference numerals indicate the same elements, and duplicate explanation thereof is not repeated.

In general, according to one embodiment, a magnetoresistive element includes a stack including a cap layer, a magnetization pinned layer, a magnetization free layer that is provided between the cap layer and the magnetization pinned layer, a tunneling insulator that is provided between the magnetization pinned layer and the magnetization free layer, and a functional layer that is provided within the magnetization pinned layer, between the magnetization pinned layer and the tunneling insulator, between the tunneling insulator and the magnetization free layer, within the magnetization free layer, or between the magnetization free layer and the cap layer, and includes an oxide including at least one element selected from Zn, In, Sn and Cd and at least one element selected from Fe, Co and Ni, and a pair of electrodes that allows electric current to flow through the stack in a direction perpendicular to the surface of the stack.

This embodiment is intended to represent a tunneling magnetoresistive (TMR) element including a spin-valve film. The spin-valve film is a stacked film including two ferromagnetic layers and a non-magnetic spacer layer sandwiched between the ferromagnetic layers, and the structural portion of the stacked film that causes a resistance change is also referred to as a spin-dependent scattering unit. The magnetization direction of one of the two ferromagnetic layers (referred to as a “pinned layer” or “magnetization pinned layer”) is fixed by, for example, an antiferromagnetic layer. The magnetization direction of the other ferromagnetic layer (referred to as a “free layer” or “magnetization free layer”) is variable by an external magnetic field. The spin-valve film achieves a high magnetoresistance by changing the angle that the magnetization directions of the two ferromagnetic layers form. In the TMR element, an electric current is allowed to flow through the spin-valve film in a direction perpendicular to the surface of the spin-valve film.

### First Embodiment

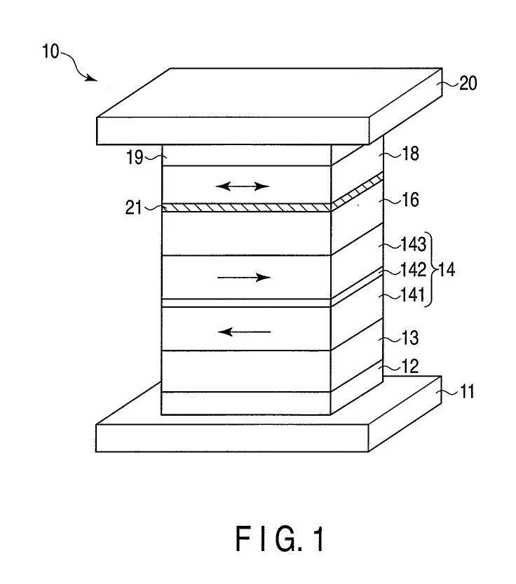

FIG. 1 shows the composition of a magnetoresistive element 10 according to a first embodiment.

The magnetoresistive element 10 according to the present embodiment includes a cap layer 19 which protects the magnetoresistive element 10 from deterioration such as oxidation, a magnetization pinned layer (hereinafter referred to as a pinned layer) 14 in which magnetization has been fixed, a magnetization free layer (hereinafter referred to as a free layer) 18 which is provided between the cap layer 19 and the pinned layer 14, and in which magnetization freely rotates, an intermediate layer (hereinafter referred to as a tunneling insulator or spacer layer) 16 which is provided between the pinned layer 14 and the free layer 18, and is made of a non-magnetic electrical insulator, and a functional layer 21 which is provided between the tunneling insulator 16 and the free layer 18 and includes an oxide that includes at least one element selected from Zn, In, Sn and Cd and at least one element selected from Fe, Co and Ni. The structure in which the components including the cap layer 19, the free layer 18, the functional layer 21, the tunneling insulator 16, and the pinned layer 14 are stacked is defined as a stack.

The magnetoresistive element 10 also includes a pair of electrodes (lower electrode 11 and upper electrode 20) which allow electric current to flow through the stack in a direction perpendicular to the surface of the stack. These electrodes are in contact with the outermost layers of the stack, respectively. The electrode on the pinned layer 14 side of the stack is referred to as the lower electrode 11, and the electrode on the free layer 18 side of the stack is referred to as the upper electrode 20. Further, the magnetoresistive element 10 includes a pinning layer 13 which is provided between the lower electrode 11 and the pinned layer 14, and is made of an antiferromagnetic substance for fixing the magnetization direction of the pinned layer 14, and an underlayer 12 provided between the pinning layer 13 and the lower electrode 11.

The lower electrode 11 and the upper electrode 20 allow electric current to flow through the magnetoresistive element 10 in a direction perpendicular to the surface of the magnetoresistive element 10. That is, when voltage is applied between the lower electrode 11 and the upper electrode 20, an electric current flows through the magnetoresistive element 10 perpendicularly to the surface of the magnetoresistive element 10.

The passage of the electric current allows the detection of the resistance change due to magnetoresistance, and thus allows the detection of magnetism. The lower electrode 11 and the upper electrode 20 are made of, for example, Cu, or Au having a relatively small electrical resistance thereby allowing electric current to flow through the magnetoresistive element 10.

The underlayer 12 has, for example, a structure in which a buffer layer and a seed layer are stacked. The buffer layer is positioned on the side of the lower electrode 11, and the seed layer is positioned on the side of the pinning layer 13.

The buffer layer reduces the effect of surface roughness of the lower electrode 11, and improves the crystallinity in the layer stacked on the buffer layer. The buffer layer may be made of, for example, Ta, Ti, V, W, Zr, Hf, Cr, or an alloy thereof. The thickness of the buffer layer is preferably 1 nm or more and 10 nm or less, and more preferably 2 nm or more and 5 nm or less. If the thickness of the buffer layer is too small, the buffer effect is lost. On the other hand, if the thickness of the buffer layer is too large, series resistance, which will not contribute to the MR ratio, will increase. When the seed layer formed on the buffer layer has a buffer effect, the buffer layer may not necessary. As a preferred example, a Ta layer may be formed to have a thickness of 3 nm.

The seed layer controls the crystalline orientation and crystal grain size in the layer stacked on the seed layer. The seed layer is preferably made of a metal having a face-centered cubic (fcc) structure, a hexagonal close-packed (hcp) structure, or a body-centered cubic (bcc) structure.

For example, the seed layer may be made of Ru having a hcp structure or NiFe having an fcc structure, such that the crystalline orientation of the overlying spin-valve film has an fcc (111) orientation. When the pinning layer 13 is made of IrMn, a good fcc (111) orientation is achieved. When the pinning layer 13 is made of PtMn, a regulated face-centered tetragonal (fct) (111) structure is obtained. When the free layer 18 and the pinned layer 14 are made of an fcc metal, a good fcc (111) orientation is achieved. When the free layer 18 and the pinned layer 14 are made of a bcc metal, a good bcc (110) orientation is achieved. The thickness of the seed layer is preferably 1 nm or more and 5 nm or less, and more preferably 1.5 nm or more and 3 nm or less, such that the seed layer sufficiently improves the crystalline orientation. As a preferred example, an Ru layer may be formed to have a thickness of 2 nm.

Alternatively, the seed layer may be made of, in place of Ru, a NiFe-based alloy (for example, NiₓFe₁₀₀₋ₓ, (x=90 to 50%, preferably 75 to 85%), or (NiₓFe₁₀₀₋ₓ)_{100-y}X_{y}[X=Cr, V, Nb, Hf, Zr, Mo]), which has been prepared by adding a third element X to NiFe thereby nonmagnetizing it, may be used. When an NiFe-based seed layer is used, a good crystalline orientation is relatively easily obtained, and a half width of the rocking curve within a range of 3 to 5° can be achieved.

The seed layer improves the crystalline orientation, and controls the crystal grain size in the spin-valve film. More specifically, the seed layer adjusts the crystal grain size in the spin-valve film from 5 nm or more and 20 nm or less, thereby achieving a high MR ratio in spite of the decrease in the size of the magnetoresistive element, without variation in the properties.

When the crystal grain size in the seed layer is 5 nm or more and 20 nm or less, diffused reflection of electrons and inelastic scattering sites caused by crystal grain boundaries are decreased. In order to achieve the crystal grain size, for example, an Ru layer is formed to have a thickness of 2 nm. When the seed layer is made of (NiₓFe₁₀₀₋ₓ)_{100-y}Z_{y} (Z=Cr, V, Nb, Hf, Zr, Mo), its thickness is preferably 2 nm, wherein the ratio y of a third element X is from about 0 to 30% (including y=0).

The crystal grain size in the spin-valve film may be determined on the basis of the size of the crystal grains in the layer interposed between the seed layer and the tunneling insulator 16 (for example, by cross-sectional TEM). For example, when the pinned layer 14 is a bottom type spin-valve film underlying the tunneling insulator 16, the crystal grain size in the spin-valve film may be determined based on the crystal grain sizes in the pinning layer 13 (antiferromagnetic layer) or the pinned layer 14 (magnetization pinned layer) formed on the seed layer.

The pinning layer 13 has a function of imparting unidirectional anisotropy to a ferromagnetic layer serving as a pinned layer 14 to be deposited thereon, thereby pinning magnetization of the ferromagnetic layer. As the material of the pinning layer 13, antiferromagnetic materials such as PtMn, PdPtMn, IrMn and RuRhMn can be used. Among them, IrMn is advantageous for application to heads adapted to high recording density. IrMn can impart unidirectional anisotropy at a smaller thickness than PtMn and is suitable for reducing a gap necessary for high density recording.

In order to impart sufficiently intense unidirectional anisotropy, the thickness of the pinning layer 13 is set appropriately. When the material of the pinning layer 13 is PtMn or PdPtMn, the thickness thereof is preferably approximately 8 to 20 nm, more preferably 10 to 15 nm. When the material of the pinning layer 13 is IrMn, it is possible to impart unidirectional anisotropy even with a thinner film than PtMn or the like, and the thickness thereof is preferably 4 to 18 nm, more preferably 5 to 15 nm. A preferable example includes Ir₂₂Mn₇₈ of about 7 nm in thickness.

As the pinning layer 13, a hard magnetic layer may be used instead of the antiferromagnetic layer. As the hard magnetic layer, for example, CoPt (Co=50 to 85%), (CoₓPt₁₀₀₋ₓ)_{100-y}Cr_{y} (x=50 to 85%, y=0 to 40%), FePt (Pt=40 to 60%) can be used. The hard magnetic layer, particular CoPt, has relatively smaller specific resistance and is thus capable of suppressing increase in series resistance and resistance-area product (RA).

The term “resistance-area product” refers to the product obtained by multiplying the sectional area of the magnetoresistive element 10 perpendicular to the stacking direction of the stacked film by the resistance obtained between the pair of electrodes when electric current is allowed to flow perpendicularly to the surface of the stacked film of the magnetoresistive element 10.

The degree of crystalline orientation of the spin-valve film and the pinning layer 13 may be determined by X-ray diffractometry. When the half width of the rocking curve at the fcc (111) peak of the spin-valve film, fct (111) peak or bcc (110) peak of the pinning layer 13 (PtMn) is, for example, 3.5 to 6°, the degree of crystalline orientation is considered to be sufficient. This can also be assessed using the dispersion angle of the diffraction spots obtained using cross-sectional TEM.

The pinned layer 14 has a structure in which a lower pinned layer 141, a magnetic coupling layer 142, and an upper pinned layer 143 are stacked in this order on the pinning layer 13.

The pinning layer 13 and the lower pinned layer 141 are bonded together by magnetic exchange coupling so as to exhibit a unidirectional anisotropy. The lower pinned layer 141 and the upper pinned layer 143 sandwiching the magnetic coupling layer 142 are strongly coupled such that the direction of magnetization are anti-parallel to each other.

The lower pinned layer 141 may be made of, for example, a CoₓFe₁₀₀₋ₓ alloy (x=0 to 100%), a NiₓFe₁₀₀₋ₓ alloy (x=0 to 100%), or any of these alloy further containing a non-magnetic element. The lower pinned layer 141 may be made of a single element such as Co, Fe or Ni, or an alloy of these elements. Alternatively, a (CoₓFe₁₀₀₋ₓ)_{100-Y}B_{X} alloy (x=0 to 100%, x=0 to 30%) may be used. From the viewpoint of reducing the variation in performance among elements each having the magnetoresistive element of a small size, the use of an amorphous alloy such as (CoₓFe₁₀₀₋ₓ)_{100-Y}B_{X} is preferred. The thickness of the lower pinned layer 141 is preferably 2 nm or more and 5 nm or less, thereby maintaining a high magnetic field intensity of the unidirectional anisotropy exhibited by the pinning layer 13 and a high magnetic field intensity for the antiferromagnetic coupling between the lower pinned layer 141 and the upper pinned layer 143 via the magnetic coupling layer 142.

If the thickness of the lower pinned layer 141 is too small, the thickness of the upper pinned layer 143 which influences the MR ratio must be decreased, which results in the decrease in the MR ratio. On the other hand, if the thickness of the lower pinned layer 141 is too large, sufficient unidirectional anisotropic magnetic field enough for device operation is hard to obtain.

It is preferable that the magnetic thickness, i.e., (saturation magnetization Bs)×(thickness t) or a product of Bs with t of the lower pinned layer 141 is substantially equal to the magnetic thickness of the upper pinned layer 143. Specifically, it is preferable that the magnetic thickness of the upper pinned layer 143 and the magnetic thickness of the lower pinned layer 141 correspond with each other.

As an example, when the upper pinned layer 143 is (Fe₄₀Co₄₀B_{20[}3 nm], the saturation magnetization of the Fe₅₀Co₅₀ in a thin film is approximately 1.75 T, so that the magnetic thickness is 1.75 T×3 nm=5.25 T nm. Since the saturation magnetization of Co₇₅Fe₂₅ is approximately 2.1 T, the thickness t of the lower pinned layer 141 which provides the magnetic thickness equal to the above value is 5.25 T nm/2.1 T=2.5 nm. Therefore, it is desirable to use Co₇₅Fe₂₅ with a thickness of approximately 2.5 nm.

The symbol ‘/’ used later represents that the elements are stacked in the order from the left of ‘/’ to the right of ‘/’, so that Au/Cu/Ru represents that a Cu layer is stacked on an Au layer, and an Ru layer is stacked on the Cu layer. The symbol ‘×2’ represents two layers, so that (Au/Cu)×2 represents that a Cu layer is stacked on an Au layer, and another Au layer and another Cu layer are stacked in this order on the Cu layer. The symbol ‘[ ]’ represents the thickness of the layer.

The magnetic coupling layer 142 allows an antiferromagnetic coupling between the lower pinned layer 141 and the upper pinned layer 143 sandwiching the magnetic coupling layer 142, thereby forming a synthetic pinned structure. The magnetic coupling layer 142 may be made of Ru, and the thickness of the magnetic coupling layer 142 is preferably 0.8 nm or more and 1 nm or less. The material of the magnetic coupling layer 142 may be other than Ru, as long as the material causes the antiferromagnetic coupling at a sufficiently high intensity between the lower pinned layer 141 and the upper pinned layer 143 sandwiching the magnetic coupling layer 142. The thickness of the magnetic coupling layer 142 may fall within a range of 0.3 to 0.6 nm which corresponds to the first peak of the Ruderman-Kittel-Kasuya-Yoshida (RKKY) coupling, instead of a range of 0.3 nm to 0.6 nm which corresponds to the second peak of the RKKY coupling. For example, Ru having a thickness of 0.9 nm may be used, thereby stably forming a more reliable coupling and achieving the function of the layer.

The upper pinned layer 143 is a magnetic layer contributing directly to the MR effect, and its constituent material and thickness are both important for obtaining a high MR ratio. In particular, the magnetic material adjacent to the tunneling insulator spacer layer 16 is important in terms of contribution to spin-dependent tunneling.

The upper pinned layer 143 may be made of Fe₅₀Co₅₀. Fe₅₀Co₅₀ is a magnetic material having a bcc structure. Since the material has a high spin-dependent interface scattering effect, it achieves a high MR ratio. Examples of FeCo alloys having a bcc structure include FeₓCo₁₀₀₋ₓ (x=30 to 100%), and FeₓCo₁₀₀₋ₓ containing an additional element. Among the materials, Fe₄₀Co₆₀ to Fe₈₀Co₂₀ which offer sufficient properties in all respects are examples to be readily used.

When the upper pinned layer 143 is made of a magnetic layer having a bcc structure which readily achieves a high MR ratio, the total thickness of the magnetic layer is preferably 1.5 nm or more, thereby maintaining a stable bcc structure. The metal material used to make a spin-valve film often has an fcc or fct structure, so that only the upper pinned layer 143 may have a bcc structure. Therefore, if the thickness of the upper pinned layer 143 is too small, a stable bcc structure may be hard to maintain, which results in a failure to achieve a high MR ratio.

Alternatively, the upper pinned layer 143 may be made of a (CoₓFe₁₀₀₋ₓ)_{100-Y}Bₓ alloy (x=0 to 100%, x=0 to 30%). The amorphous alloy such as (CoₓFe₁₀₀₋ₓ)_{100-Y}B_{X} is preferred from the viewpoint of reducing the variation in performance among elements due to the effects of crystal grains which cannot be ignored in small magnetoresistive elements. In addition, the upper pinned layer 143 made of the amorphous alloy is so flat that the tunnel insulator formed on the upper pinned layer 143 is also flattened. Flattening of the tunnel insulator reduces the frequency of defects in the tunnel insulator, and thus is important for achieving a high MR ratio with a low RA. In particular, when MgO is used as the material of the tunnel insulator, the use of an amorphous alloy such as (CoₓFe₁₀₀₋ₓ)_{100-Y}Bₓ increases the (100) orientation of the MgO layer formed on the tunnel insulator. The (100) orientation of the MgO layer is important for achieving a high MR ratio. In addition, the (CoₓFe₁₀₀₋ₓ)_{100-Y}Bₓ alloy is crystallized upon annealing with the (100) plane of MgO as the template, and thus achieves a good crystal lattice match between the MgO and (CoₓFe₁₀₀₋ₓ)_{100-Y}Bₓ alloy. The good crystal lattice match is important for achieving a high MR ratio.

In order to achieve a high MR ratio, the upper pinned layer 143 preferably has a large thickness. On the other hand, in order to achieve a pinned magnetic field of high intensity, the thickness is preferably small. Therefore, there is a trade-off relationship. For example, when an FeCo alloy layer having a bcc structure is used, a thickness of 1.5 nm or more is preferred, thereby stabilizing the bcc structure. Also when a CoFe alloy layer having an fcc structure is used, a thickness of 1.5 nm or more is preferred, thereby achieving a high MR ratio. On the other hand, in order to achieve a pinned magnetic field of high intensity, the upper pinned layer 143 preferably has a thickness of 5 nm or less, and more preferably 4 nm or less. As described above, the thickness of the upper pinned layer 143 is preferably 1.5 nm or more and 5 nm or less, and more preferably 2.0 nm or more and 4 nm or less.

The upper pinned layer 143 may be made of, in place of a magnetic material having a bcc structure, a Co₉₀Fe₁₀ alloy having an fcc structure, or Co or a Co alloy having an hcp structure, which are widely used in conventional magnetoresistive elements. The upper pinned layer 143 may be made of a single metal such as Co, Fe, or Ni, or an alloy material containing any of these elements. As the magnetic material of the upper pinned layer 143, an FeCo alloy material having a bcc structure, a cobalt alloy containing 50% or more cobalt, or an Ni alloy containing 50% or more Ni is advantageous in achieving a high MR ratio.

The upper pinned layer 143 may be a Heusler alloy layer such as Co₂MnGe, Co₂MnSi, or Co₂MnAl.

The tunneling insulator 16 interrupts the magnetic coupling between the pinned layer 14 and the free layer 18. The tunneling insulator 16 may be made of a non-magnetic oxide containing at least one element selected from Mg, Al, Ti, Zr, Hf and Zn. In particular, MgO exhibits a coherent spin-dependent tunneling phenomenon, and thus is preferred for achieving a high MR ratio. The thickness of the tunneling insulator 16 is preferably 1 nm or more and 4 nm or less.

The free layer 18 includes a ferromagnetic substance whose magnetization direction is changed by the external magnetic field. For example, the free layer 18 may have a two-layer structure of Co₉₀Fe₁₀ [1 nm]/Ni₈₃Fe_{17 [}3.5 nm] obtained by forming an NiFe layer and a CoFe layer in this order. When the NiFe layer is not used, a single layer of Co₉₀Fe_{10 [}4 nm] may be used. The free layer 18 may have a three-layer structure such as CoFe/NiFe/CoFe.

Among CoFe alloys, Co₉₀Fe₁₀ having stable soft magnetic properties is preferred as the material of the free layer 18. When a CoFe alloy having a composition close to that of the Co₉₀Fe₁₀ is used, the thickness is preferably 0.5 nm or more and 4 nm or less. A CoₓFe₁₀₀₋ₓ (x=70 to 90%) may be used instead.

The material of the upper pinned layer 143 may be a (CoₓFe₁₀₀₋ₓ)_{100-Y}Bₓ alloy (x=0 to 100%, x=0 to 30%). The amorphous alloy such as (CoₓFe₁₀₀₋ₓ)_{100-Y}B_{X} is preferred from the viewpoint of reducing the variation in performance among elements due to the effects of crystal grains which cannot be ignored in small magnetoresistive elements. When the spacer layer is made of MgO, the (CoₓFe₁₀₀₋ₓ)_{100-Y}Bₓ alloy is crystallized upon annealing with the (100) plane of MgO as the template, and thus achieves a good crystal lattice match between the MgO and (CoₓFe₁₀₀₋ₓ)_{100-Y}Bₓ alloy. The good crystal lattice match is important for achieving a high MR ratio.

The free layer 18 may be a stack in which CoFe or Fe layers having a thickness of 1 nm or more and 2 nm or less and very thin Cu layers having a thickness of 0.1 nm or more and 0.8 nm or less are stacked alternately.

The free layer 18 may includes an amorphous magnetic layer such as a CoZrRb layer, as long as the free layer further includes a magnetic layer having a crystal structure at its interface in contact with the spacer layer 16, which gives a marked influence on the MR ratio. The free layer 18 may have the following structures when observing the spacer layer 16 side. More specifically, the free layer 18 may be, for example, (1) a crystal layer alone, (2) a stack of a crystal layer/an amorphous layer, (3) a stack of a crystal layer/an amorphous layer/a crystal layer, etc. Here, it is important that in all of the (1) to (3), a crystal layer is in contact with the spacer layer 16.

The cap layer 19 has a function of protecting the spin-valve film. The cap layer 19 can be a plurality of metal layers, for example, a two-layer structure of a Cu layer and an Ru layer (Cu [1 nm]/Ru [10 nm]). Further, as the cap layer 19, a Ru/Cu layer in which an Ru layer is placed on the side of the free layer 18 can also be used. In this case, the thickness of the Ru layer is preferably approximately 0.5 to 2 nm. The cap layer 19 of this structure is desirable especially when the free layer 18 is made of NiFe. This is because it can reduce magnetostriction in a mixed interface layer formed between the free layer 18 and the cap layer 19 since Ru is insoluble with Ni.

When the cap layer 19 is either of Cu/Ru or Ru/Cu, the thickness of the Cu layer is preferably approximately 0.5 to 10 nm, and the thickness of the Ru layer is preferably approximately 0.5 to 5 nm. Since Ru has a high specific resistance value, use of an excessively thick Ru layer is not favorable.

As the cap layer 19, a metal layer other than the Cu layer or Ru layer may be provided. For the cap layer 19, another material may be used as long as it can protect the spin-valve film. However, selection of a cap layer may change the MR ratio or the long-term reliability, and therefore care must be taken. In these views, Cu and Ru are desirable examples of a material for the cap layer.

The functional layer 21 has a spin-filter effect that allows control of the permeation of upspin or downspin electrons. The functional layer 21 includes an oxide made of at least one element of Zn, In, Sn and Cd and at least one element of Fe, Co and Ni. For example, a mixed oxide of Fe₅₀Co₅₀ and Zn may be used. Zn is more preferred to In, Sn, and Cd, because Zn, Fe, Co, and Ni are in the same period of the periodic table, so that the mixed oxide of Zn with Fe, Co, or Ni is readily magnetized to stabilizes the magnetization of the functional layer 21.

The use of these materials achieves a high spin-filter effect and spin-flip reduction owing to a low resistivity, which results in the increase of the MR ratio of the magnetoresistive element 10.

In view of achieving a spin-filteringspin-filtering layer having a low resistivity, it is effective that the spin-filteringspin-filtering layer includes the above-described oxide material containing Zn, In, Sn, or Cd, such as ZnO, In₂O₃, SnO₂, ZnO, CdO, CdIn₂O₄, Cd₂SnO₄, or Zn₂SnO₄. One of the reasons why these oxide materials exhibit a low resistivity is considered as follows. These oxide semiconductors have a band gap of 3 eV or more. When the oxide semiconductors are slightly reduced from the stoichiometry, an intrinsic defect such as oxygen vacancy forms a donor level, so that the conduction electron density reaches about 10¹⁸ to 10¹⁹ cm⁻³. In the band structure of these conductive oxides, the valence band is mainly offered by the 2p orbital of oxygen atoms, and the conduction band is offered by the s orbital of metal atoms. When the carrier density at the Fermi level exceeds 10¹⁸ cm⁻³, the conduction band is reached, and a so-called degeneracy state occurs. The oxide semiconductor is referred to as n-type degenerate semiconductor which has sufficient concentration and mobility of conduction electrons, and thus achieves a low resistivity. If any oxide material does not fit in the theory, it may be used as long as it exhibits a low resistivity.

On the other hand, in order to achieve a spin-filteringspin-filtering layer having a high spin-filter effect, spin-filteringuse of spin-filtering layers containing Co, Fe, and Ni oxides having magnetism at room temperature is effective. The oxide materials containing Zn, In, Sn, and Cd, which are effective for achieving a low resistivity, do not have magnetism in a bulk state. Jpn. Pat. Appln. KOKAI Publication No. 2004-6589 discloses that the insertion of a very thin oxide layer into the free layer or pinned layer of a non-magnetic oxide material develops magnetism therein, and thus achieving a spin-filter effect. However, higher spin-filter effects will be achieved by the addition of Co, Fe, and Ni oxides which readily develop magnetism without limited by the thickness of the oxide layer.

The functional layer 21 may further contain an additional element. It is reported that the addition of Al to a Zn oxide improves the heat resistance. Examples of the additional element other than Al include B, Ga, In, C, Si, Ge and Sn. The mechanism of the improvement of heat resistance is not completely evident, but is presumed to be as follows. That is, the heat-accelerated reoxidation decreases the density of the oxygen vacancy in the Zn oxide produced by slight reduction from the stoichiometry and thus changes the carrier density. As other reason for the improvement of the heat resistance, it is presumed that the above-described elements, which correspond to the dopants of Group III or IV, prevent the acceleration of reoxidation of Zn atom due to heat, thus the change in the carrier density in the functional layer 21 and the resistivity change caused by heat are minimized.

The thickness of the functional layer 21 is preferably 0.5 nm or more thereby achieving a sufficient spin-filteringspin-filter effect. In order to obtain a higher uniformity of the functional layer 21, in consideration of the dependence on the manufacturing equipment, the thickness is more preferably 1 nm or more. On the other hand, the upper limit of the thickness is preferably 10 nm or less from the viewpoint of preventing the increase of the read-gap of the reproducing head.

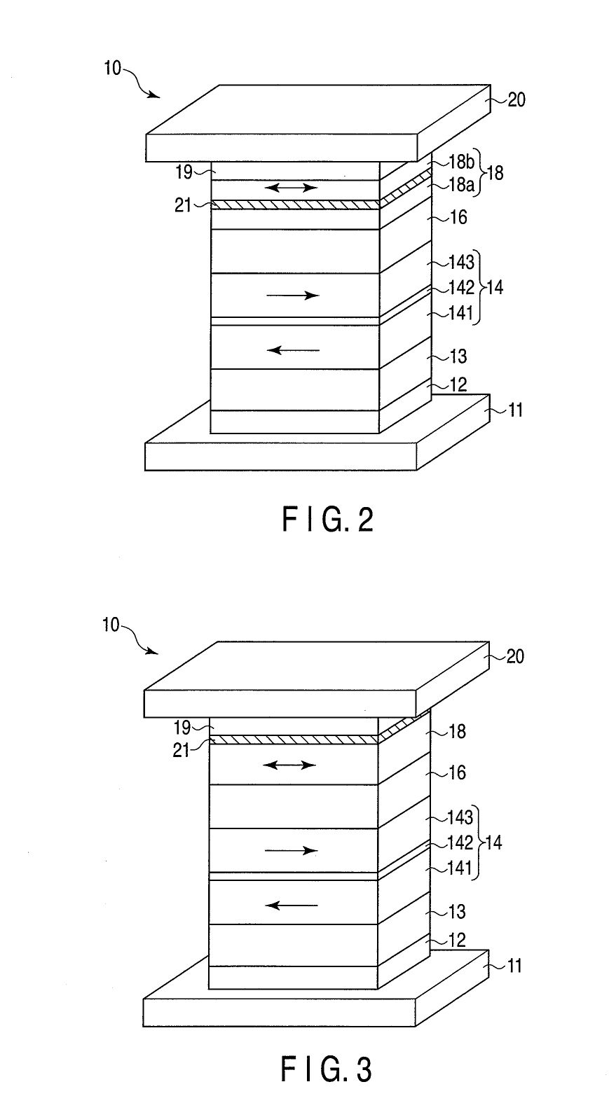

The position of the functional layer 21 is not limited to the position between the free layer 18 and tunneling insulator 16 as shown in FIG. 1. For example, the functional layer 21 may be inserted at the positions shown in FIGS. 2, 3, 4, 5, 6 and 7. The details will be described below in Modifications.

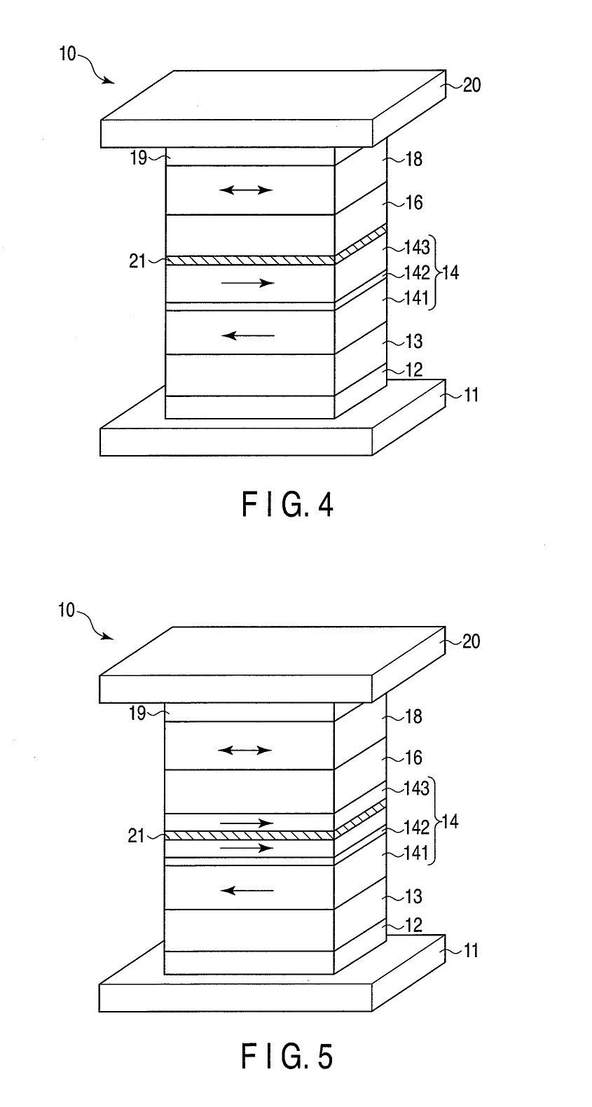

The influence of the spin difference on the electron behavior is most remarkable when the electrons pass through the interface between the ferromagnetic layers (free layer 18 or pinned layer 14) and non-magnetic layer (tunneling insulator 16). Accordingly, the functional layer 21 at the interface enhances the effect of the functional layer 21. More specifically, as shown in FIG. 1 or 4, the functional layer 21 is preferably provided between the tunneling insulator 16 and the free layer 18 or the pinned layer 14. Alternatively, it is more preferred that, as shown in FIG. 7, a functional layer 22 be provided between the free layer 18 and the tunneling insulator 16 and the functional layer 21 be provided between the tunneling insulator 16 and the pinned layer 14.

When the functional layer 21 is formed at the interface between the free layer 18 and the tunneling insulator 16, the free layer 18 is preferably a soft magnetic film having better soft magnetic properties than a magnetic compound, thereby improving the magnetic field response. This applies to the cases where the functional layer 21 is provided within the free layer 18, or at the interface between the free layer 18 and the cap layer 19, as will be described in Modifications later. The free layer 18 may be made of a single metal such as Co, Fe, or Ni, or all alloy materials containing any one of these elements. In particular, as described above, a two-layer structure of Co₉₀Fe_{10 [}1 nm]/Ni₈₃Fe_{17 [}3.5 nm] obtained by forming an NiFe layer and a CoFe layer in this order, a three-layer structure of CoFe/NiFe/CoFe, or a single layer of a Co—Fe alloy may be used.

When the functional layer 21 is formed at the interface between the pinned layer 14 and the tunneling insulator 16, within the pinned layer 14, or at the interface between the magnetic coupling layer 142 and the pinned layer 14, the upper pinned layer 143 may be made of a material which is more easily pinned in a single direction than the functional layer 21, thereby improving the pinning properties. The material of the upper pinned layer 143 may be a single metal such as Co, Fe or Ni, or all alloy materials containing any one of these elements.

When the functional layer 21 is formed at the interface between the free layer 18 and the tunneling insulator 16, or at the interface between the pinned layer 14 and the tunneling insulator 16, the spin-filteringspin-filter effect of the functional layer 21 enhances the spin-dependent tunneling effect, which results in the increase of the MR ratio. Also when the functional layer 21 is provided within the free layer 18, at the interface between the free layer 18 and the cap layer 19, within the pinned layer 14, or at the interface between the upper pinned layer 141 and the magnetic coupling layer 142, the spin-filteringspin-filter effect of the functional layer 21 enhances the spin-dependent tunneling effect, whereby increasing the MR ratio.

A plurality of functional layers 21 may be provided within the free layer 18 or the pinned layer 14. For example, when the functional layers 21 are provided at the interface between the tunneling insulator 16 and the free layer 18 and within the free layer 18, the functional layers 21 further enhances the spin-dependent tunneling effect, thereby achieving a high MR ratio. However, if the number of the functional layer 21 is too much, the resistance is increased, which results in the occurrence of spin-flip. Therefore, the number of the functional layer 21 is limited to an appropriate value. For example, about four layers may be provided within the free layer 18 or the pinned layer 14.

As shown in FIG. 1, when the functional layer 21 is formed at the interface between the free layer 18 and the tunneling insulator 16, the functional layer 21 contributes to the spin-dependent tunneling effect as described above.

The method for manufacturing the magnetoresistive element 10 according to the present embodiment is described below.

In the present embodiment, the film formation method used in manufacture of the element may be, for example, a sputtering method such as DC magnetron sputtering or RF magnetron sputtering, ion beam sputtering, vapor deposition, chemical vapor deposition (CVD), or molecular beam epitaxy (MBE).

Firstly, the lower electrode 11 is formed on a substrate by micromachining process. Subsequently, for example, Ta [1 nm]/Ru [2 nm] is formed as the underlayer 12 on the lower electrode 11. The Ta corresponds to a buffer layer which reduces the roughness of the lower electrode 11. The Ru layer corresponds to a seed layer which controls the crystalline orientation and crystal grain size in the spin valve layer formed thereon.

Then, the pinning layer 13 is formed on the underlayer 12. The material of the pinning layer 13 may be an antiferromagnetic material such as PtMn, PdPtMn, IrMn, or RuRhMn.

The pinned layer 14 is formed on the pinning layer 13. The pinned layer 14 may be, for example, a synthetic pinned layer made of the lower pinned layer 141 (Co₇₅Fe_{25 [}2.5 nm]), the magnetic coupling layer 142 (Ru), and the upper pinned layer 143 (Co₅₀Fe₅₀ [1 nm]/Co₄₀Fe₄B_{20 [}2 nm]).

The tunneling insulator 16 is formed on the pinned layer 14. The tunneling insulator 16 is formed with a non-magnetic oxide containing at least one element selected from Mg, Al, Ti, Zr, Hf and Zn.

Thereafter, the functional layer 21 is formed on the tunneling insulator 16. Specifically, a metal layer made of Fe₅₀Co₅₀ and Zn is formed on the upper pinned layer 143. The metal layer made of Fe₅₀Co₅₀ and Zn may be a stack of Fe₅₀Co₅₀ and Zn layers such as Fe₅₀Co₅₀/Zn, Zn/Fe₅₀Co₅₀, or (Fe₅₀Co₅₀/Zn)×2, or a single layer of an alloy such as Zn₅₀(Fe₅₀Co₅₀)₅₀. A metal material containing Zn and Fe₅₀Co₅₀ is oxidized to form the functional layer 21. The conversion treatment may use ion-assisted oxidation (IAO), which is carried out by feeding oxygen to the metal material layer under irradiation with rare gas ion beams or plasma. In the ion-assisted conversion treatment, oxygen gas ion beams or plasma may be used. The energy assistance using ion beam irradiation in the treatment of the metal material layer allows the formation of a stable and uniform oxide layer as the functional layer 21. In order to form the functional layer 21 having a single layer structure, the formation and conversion treatment of the above-described metal material layer may be repeated several times. In this case, instead of performing the film formation and conversion each only one-time in order to form the functional layer 21 having a predetermined thickness, it is more preferred that formation of a thinner metal material layer and the conversion treatment thereof are repeated alternately. Alternatively, the metal material layer containing Zn and Fe₅₀Co₅₀ may be exposed to an oxygen atmosphere for natural oxidation. In order to form a stable oxide, energy-assisted oxidation is preferred. Alternatively, a stack of Zn and Fe₅₀Co₅₀ metal materials is preferably oxidized under irradiation with an ion beam, thereby forming the functional layer 21 made of uniformly mixed Zn with Fe₅₀Co₅₀.

The energy assistance may use heat treatment in place of the irradiation with an ion beam. In this case, for example, oxygen may be fed to the formed metal material layer under heating at 100 to 300° C.

The beam conditions for ion beam-assisted conversion treatment for forming the functional layer 21 are described below. When the formation of the functional layer 21 by conversion treatment uses the above-described irradiation with rare gas ions or plasma, the accelerating voltage V is preferably from 30 to 130 V, and the beam electric current Ib is preferably from 20 to 200 mA. These conditions are markedly milder in comparison with the conditions for ion beam etching. The functional layer 21 may be formed in the same manner using plasma such as RF plasma in place of ion beams. The angle of incidence of the ion beam is changed as appropriate from 0 to 80°, based on the definition that the angle of the beam perpendicular to the layer surface is 0°, and that parallel to the layer surface is 90°. The treatment time of the process is preferably from 15 seconds to 1200 seconds, and more preferably 30 seconds or more, from the viewpoint of controllability. If the treatment time is too long, the productivity of the magnetoresistive element deteriorates. From these viewpoints, the treatment time is preferably from 30 seconds to 600 seconds.

In the oxidation treatment using ions or plasma, the oxygen exposure dose is preferably from 1×10³ to 1×10⁴ L [Langmiur, 1 L=1×10⁻⁶ Torr×sec] for IAO, or from 3×10³ to 3×10⁴ L for natural oxidation.

Then, the free layer 18 is formed on the functional layer 21. The free layer 18 is, for example, Fe₅₀Co_{50 [}1 nm]/Ni₈₅Fe_{15 [}3.5 nm].

The cap layer 19 is formed on the free layer 18. The cap layer 19 may be, for example, Cu [1 nm]/Ru [10 nm].

Thereafter, annealing treatment is carried out.

Finally, the upper electrode 20 for allowing electric current to flow through the magnetoresistive element 10 in a direction perpendicular to the magnetoresistive element 10 is formed on the cap layer 19.

(Modification 1)

FIG. 2 shows a first modification of the magnetoresistive element 10 according to the first embodiment.

The present modification is different from the first embodiment in that a functional layer 21 is provided within a free layer 18. The free layer 18 includes a first free layer 18a and a second free layer 18b. The first free layer 18a is provided between a tunneling insulator 16 and the functional layer 21, and the second free layer 18b is provided between a cap layer 19 and the functional layer 21.

When the functional layer 21 is formed within the free layer 18, the tunneling insulator 16, the functional layer 21, and the second free layer 18b are formed on the first free layer 18a in this order.

In this manner, even when the functional layer 21 is provided within the free layer 18, the functional layer 21 contributes to spin-dependent tunneling as described above. In addition, the functional layer 21 forms a magnetic coupling with the free layer 18, so that its magnetization direction is unfixed like in the free layer 18, and thus contributes to the increase of the MR ratio of the magnetoresistive element 10, without inhibiting the function of the free layer 18. In addition, dispersion of oxygen contained in the functional layer 21 into the tunneling insulator 16 is reduced, so that the occurrence of spin-flip in the tunneling insulator 16 caused by the elemental oxygen in the tunneling insulator 16 is prevented, whereby a high MR ratio is achieved.

(Modification 2)

FIG. 3 shows a second modification of the magnetoresistive element 10 according to the first embodiment.

The present modification is different from the first embodiment in that a functional layer 21 is provided between a free layer 18 and a cap layer 19.

In this manner, even when the functional layer 21 is provided between the free layer 18 and the cap layer 19, as described above, the functional layer 21 contributes to spin-dependent tunneling. In addition, since the functional layer 21 is made of an oxide, it protects the magnetoresistive element 10 from deterioration such as oxidation. Further, dispersion of oxygen contained in the functional layer 21 into a spacer layer 16 is reduced, so that the occurrence of spin-flip in the spacer layer 16 caused by the elemental oxygen in the spacer layer 16 is prevented, whereby a high MR ratio is achieved.

(Modification 3)

FIG. 4 shows a third modification of the magnetoresistive element 10 according to the first embodiment.

The present modification is different from the first embodiment in that a functional layer 21 is provided between a pinned layer 14 and a tunneling insulator 16.

In this manner, when the functional layer 21 is provided between the pinned layer 14 and the tunneling insulator 16, the functional layer 21 contributes to spin-dependent tunneling as described above. In addition, since the functional layer 21 is made of an oxide, it prevents mixing of the material of the tunneling insulator 16 with the material of the pinned layer 14. As a result of this, the tunneling insulator 16 allows conduction electrons to pass therethrough while preventing spin-flip, and stably fixes the magnetization of the pinned layer 14.

(Modification 4)

FIG. 5 shows a fourth modification of the magnetoresistive element 10 according to the first embodiment.

The present modification is different from the first embodiment in that a functional layer 21 is provided within an upper pinned layer 143.

In this manner, even when the functional layer 21 is provided within the upper pinned layer 143, as described above, the functional layer 21 contributes to spin-dependent tunneling. In addition, when the functional layer 21 is arranged at a position not in contact with a tunneling insulator, dispersion of oxygen contained in the functional layer 21 into the tunneling insulator is reduced, so that the occurrence of spin-flip in the tunneling insulator caused by the oxygen element in the tunneling insulator is prevented, whereby a high MR ratio is achieved.

(Modification 5)

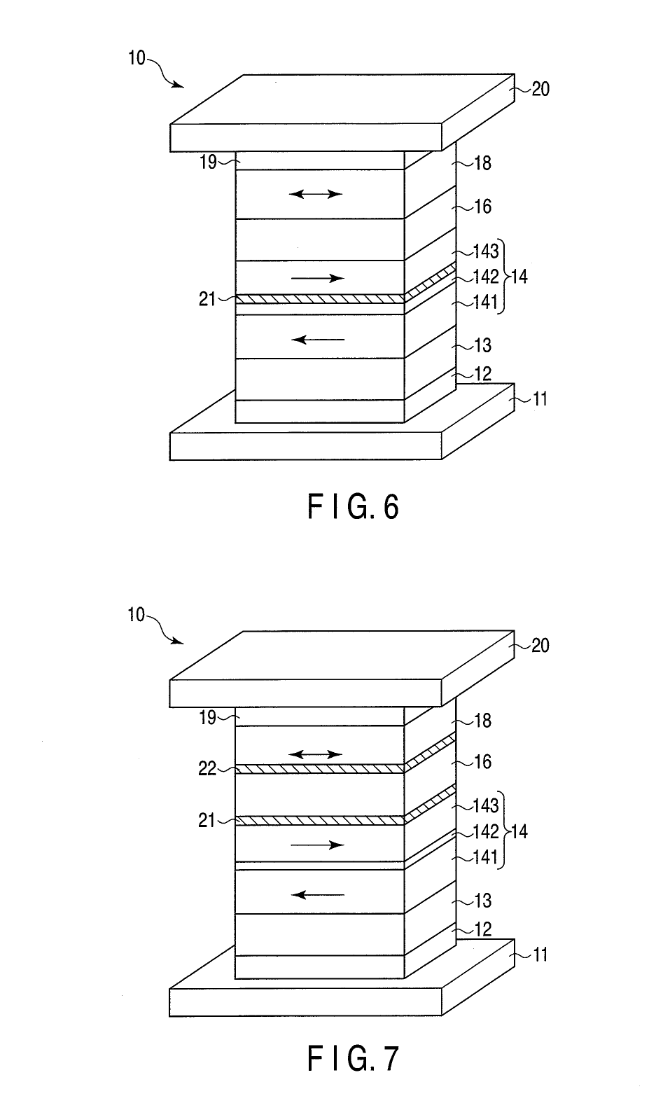

FIG. 6 shows a fifth modification of the magnetoresistive element 10 according to the first embodiment.

The present modification is different from the first embodiment in that a functional layer 21 is provided between an upper pinned layer 143 and a magnetic coupling layer 142.

In this manner, even when the functional layer 21 is provided between the upper pinned layer 143 and the magnetic coupling layer 142, the functional layer 21 contributes to spin-dependent tunneling as described above. When the functional layer 21 is arranged at a position not in contact with the tunneling insulator, dispersion of oxygen contained in the functional layer 21 into a tunneling insulator is reduced, so that the occurrence of spin-flip in the tunneling insulator caused by the oxygen element in the tunneling insulator is prevented, whereby a high MR ratio is achieved.

(Modification 6)

FIG. 7 shows a sixth modification of the magnetoresistive element 10 according to the first embodiment.

The present modification is different from the first embodiment in that a functional layer 21 is provided between an upper pinned layer 143 and a tunneling insulator 16, and that a second functional layer 22 is provided between a tunneling insulator 16 and a free layer 18.

The composition of the functional layer 21 is the same as that of the functional layer 22, so that the explanation thereof is not repeated here.

In this manner, a synergistic spin-filteringspin-filter effect of the two functional layers is achieved by forming the functional layer 21 and the second functional layer 22 between the upper pinned layer 143 and the tunneling insulator 16, and between the tunneling insulator 16 and the free layer 18, respectively. As a result of this, a higher MR ratio is achieved in comparison with the case using a single functional layer.

The magnetoresistive elements 10 according to Modifications 1 to 6 may be manufactured using the method for manufacturing the magnetoresistive element 10 described in the first embodiment, so that the explanations of the methods for making the magnetoresistive elements 10 according to Modifications 1 to 6 are not repeated here.

### EXAMPLES

The magnetoresistive element 10 according to the first embodiment and Modifications 1 to 6 were manufactured, and electric current was allowed to perpendicularly flow between the lower electrode 11 and the upper electrode 20, thereby evaluating the RA value and the MR ratio of the magnetoresistive elements 10.

### Example 1

The magnetoresistive element 10 according to the first embodiment was manufactured, and the RA value and the MR ratio thereof were evaluated. More specifically, as shown in FIG. 1, a structure including the functional layer 21 provided between the tunneling insulator 16 and the free layer 18 was formed.

The functional layer 21 was formed as follows. Fe₅₀Co₅₀ was formed to have a thickness of 1 nm on the tunneling insulator 16 made of MgO, and Zn was formed to have a thickness of 0.6 nm thereon. Thereafter, IAO was carried out thereby achieving conversion into an oxide of Zn and Fe₅₀Co₅₀ (hereinafter expressed as Zn—Fe₅₀Co₅₀—O), and thus forming the functional layer 21. The thickness of the functional layer 21 was 1.8 nm. At this point, the oxygen exposure dose used in the IAO was 1.5×10⁴ L. Thereafter, Fe₅₀Co_{50 [}1 nm]/Ni₈₅Fe_{15 [}3.5 nm] was formed on the functional layer 21, thereby forming the free layer 18. Finally, annealing treatment was carried out at 280° C. for 5 hours, thereby forming the lower electrode 11 and the upper electrode 20.

In the following Examples, the method for forming the functional layer is the same as described above, so that the explanation thereof is not repeated here.

The composition of the magnetoresistive element 10 formed in the present example is described below.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]/Fe₅₀Co_{50 [}1 nm]/(Fe₅₀Co₅₀)₈₀B_{20 [}2 nm]

Tunneling insulator 16: MgO [1.5 nm]

Functional layer 21: Zn—Fe₅₀Co₅₀—O [1.8 nm]

Free layer 18: Fe₅₀Co_{50 [}0.5 nm]/Ni₈₅Fe₁₅ [3 nm]

Cap layer 19: Cu [1 nm]/Ta [2 nm]/Ru [15 nm]

The RA of the magnetoresistive element 10 according to the present example was 1.1 Ωμm², and the MR ratio was 63%.

### Example 2

The magnetoresistive element 10 according to Modification 1 was manufactured, and the RA value and the MR ratio thereof were evaluated. More specifically, as shown in FIG. 2, a structure including the functional layer 21 within the free layer 18 was formed.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]/Fe₅₀Co_{50 [}1 nm]/(Fe₅₀Co₅₀)₈₀B_{20 [}2 nm]

Tunneling insulator 16: MgO [1.5 nm]

Free layer 18A: (Fe₅₀Co₅₀)₈₀B_{20 [}0.5 nm]

Functional layer 21: Zn—Fe₅₀Co₅₀—O [1.8 nm]

Free layer 18B: /Ni₈₅Fe_{15 [}3 nm]

Cap layer 19: Cu [1 nm]/Ta [2 nm]/Ru [15 nm]

The RA of the magnetoresistive element 10 according to the present example was 1.2 Ωμm², and the MR ratio was 59%.

### Example 3

The magnetoresistive element 10 according to Modification 2 was manufactured, and the RA value and the MR ratio thereof were evaluated. More specifically, as shown in FIG. 3, a structure including the functional layer 21 between the cap layer 19 and the free layer 18 was formed.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]/Fe₅₀Co_{50 [}1 nm]/(Fe₅₀Co₅₀)₈₀B₂₀ 2 nm]

Tunneling insulator 16: MgO [1.5 nm]

Free layer 18: (Fe₅₀Co₅₀)₈₀B₂₀ [1 nm]/Ni₈₅Fe_{15 [}3 nm]

Functional layer 21: Zn—Fe₅₀Co₅₀—O [1.8 nm]

Cap layer 19: Cu [1 nm]/Ta [2 nm]/Ru [15 nm]

The RA of the magnetoresistive element 10 according to the present example was 1.2 Ωμm², and the MR ratio was 54%.

### Example 4

The magnetoresistive element 10 according to Modification 3 was manufactured, and the RA value and the MR ratio thereof were evaluated. More specifically, as shown in FIG. 4, a structure including the functional layer 21 between the tunneling insulator 16 and the upper pinned layer 143 was formed.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]/Fe₅₀Co_{50 [}0.5 nm]/(Fe₅₀Co₅₀)₈₀B_{20 [}1 nm]

Functional layer 21: Zn—Fe₅₀Co₅₀—O [1.8 nm]

Tunneling insulator 16: MgO [1.5 nm]

Free layer 18: (Fe₅₀Co₅₀)₈₀B₂₀ [1 nm]/Ni₈₅Fe_{15 [}3 nm]

Cap layer 19: Cu [1 nm]/Ta [2 nm]/Ru [15 nm]

The RA of the magnetoresistive element 10 according to the present example was 1.1 Ωμm², and the MR ratio was 65%.

### Example 5

The magnetoresistive element 10 according to Modification 4 was manufactured, and the RA value and the MR ratio thereof were evaluated. More specifically, as shown in FIG. 5, a structure including the functional layer 21 within the upper pinned layer 143 was formed.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]/Fe₅₀Co_{50 [}0.5 nm]

Functional layer 21: Zn—Fe₅₀Co₅₀—O [1.8 nm]

Pinned layer 143B: (Fe₅₀Co₅₀)₈₀B_{20 [}1 nm]

Tunneling insulator 16: MgO [1.5 nm]

Free layer 18: (Fe₅₀Co₅₀)₈₀B₂₀ [2 nm]/Ni₈₅Fe_{15 [}3 nm]

Cap layer 19: Cu [1 nm]/Ta [2 nm]/Ru [15 nm]

The RA of the magnetoresistive element 10 according to the present example was 1.1 Ωμm², and the MR ratio was 60%.

### Example 6

The magnetoresistive element 10 according to Modification 5 was manufactured, and the RA value and the MR ratio thereof were evaluated. More specifically, as shown in FIG. 6, a structure including the functional layer 21 between the upper pinned layer 143 and the magnetic coupling layer 142 was formed.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]

Functional layer 21: Zn—Fe₅₀Co₅₀—O [1.8 nm]

Pinned layer 143B: (Fe₅₀Co₅₀)₈₀B_{20 [}1.5 nm]

Tunneling insulator 16: MgO [1.5 nm]

Free layer 18: (Fe₅₀Co₅₀)₈₀B₂₀ [2 nm]/Ni₈₅Fe_{15 [}3 nm]

Cap layer 19: Cu [1 nm]/Ta [2 nm]/Ru [15 nm]

The RA of the magnetoresistive element 10 according to the present example was 1.2 Ωμm², and the MR ratio was 54%.

### Example 7

The magnetoresistive element 10 according to Modification 6 was manufactured, and the RA value and the MR ratio thereof were evaluated. More specifically, as shown in FIG. 7, a structure including the functional layer 22 between the free layer 18 and the tunneling insulator 16, and the functional layer 21 between the tunneling insulator 16 and the upper pinned layer 143 was formed.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]/Fe₅₀Co_{50 [}0.5 nm]/(Fe₅₀Co₅₀)₈₀B_{20 [}1 nm]

Functional layer 21: Zn—Fe₅₀Co₅₀—O [1.8 nm]

Tunneling insulator 16: MgO [1.5 nm]

Functional layer 22: Zn—Fe₅₀Co₅₀—O [1.8 nm]

Free layer 18: (Fe₅₀Co₅₀)₈₀B₂₀ [0.5 nm]/Ni₈₅Fe_{15 [}3 nm]

Cap layer 19: Cu [1 nm]/Ta [2 nm]/Ru [15 nm]

The RA of the magnetoresistive element 10 according to the present example was 1.2 Ωμm², and the MR ratio was 68%.

### Comparative Example 1

A magnetoresistive element including no functional layer was manufactured, and the RA value and the MR ratio thereof were evaluated.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]/Fe₅₀Co_{50 [}1 nm]/(Fe₅₀Co₅₀)₈₀B_{20 [}2 nm]

Tunneling insulator 16: MgO [1.5 nm]

Free layer 18: (Fe₅₀Co₅₀)₈₀B₂₀ [2 nm]/Ni₈₅Fe_{15 [}3 nm]

Cap layer 19: Cu [1 nm]/Ta [2 nm]/Ru [15 nm]

The RA of the magnetoresistive element 10 according to the present comparative example was 1.1 Ωμm², and the MR ratio was 51%.

The MR ratios of the magnetoresistive elements 10 according to Examples 1 to 7 were greater than the MR ratio of Comparative Example 1, indicating that the magnetoresistive elements 10 according to the first embodiment and Modifications 1 to 6 increase the MR ratio.

The increase of the MR ratio is presumed to be as follows. That is, the functional layer has achieved a high spin-filter effect and reduced spin-flip owing to a low resistivity. A spin-filtering oxide layer tends to be a material having a high resistivity, so that tends to have a high resistance. In general, when electrons pass through a layer having a high resistance, spin-flip tends occur to lose spin information, and the occurrence of spin-flip results in the decrease of the MR ratio. The reduction of spin-flip in a spin-filtering oxide layer may yield further increase of the MR ratio.

### Examples 8 to 10

The relationship between the resistance of the functional layer 21 and the MR ratio of the magnetoresistive element 10 was studied. Specifically, the sheet resistance of the functional layer 21 alone was measured, and the MR ratio of the magnetoresistive element 10 including another functional layer 21, which was made in the same manner as the above-described functional layer 21, was measured. Based on these measurements, the influence of the resistance of the functional layer 21 on the MR ratio of the magnetoresistive element 10 was evaluated.

The functional layer 21 was formed as follows. An FeCo layer having a thickness of 1 nm was formed, a Zn layer having a thickness of 0.6 nm was stacked thereon, and subjected to IAO treatment to form an oxide. The cycle was repeated 30 times in total, thereby forming the functional layer 21. The oxygen exposure dose used in the IAO was 3.0×10⁴ L (Comparative Example 3), 1.2×10⁴ L (Example 8), 1.5×10⁴ L (Example 9), or 1.8×10⁴ L (Example 10). Here, “L” is Langmuir unit. In this manner, four types of the functional layer 21 were formed.

The magnetoresistive element 10 including the functional layer 21 was manufactured by stacking the following layers sequentially on the lower electrode 11.

Underlayer 12: Ta [1 nm]/Ru [2 nm]

Pinning layer 13: Ir₂₂Mn_{78 [}7 nm]

Pinned layer 14: Co₇₅Fe_{25 [}2.5 nm]/Ru [0.9 nm]/Fe₅₀Co_{50 [}1 nm]/(Fe₅₀Co₅₀)₈₀B_{20 [}2 nm]

Tunneling insulator 16: MgO [1.5 nm]

Functional layer 21: Zn—Fe₅₀Co₅₀—O [1.8 nm]

Free layer 18: (Fe₅₀Co₅₀)₈₀B₂₀ [1 nm]/Ni₈₅Fe_{15 [}3 nm]

Cap layer 19: Cu [1 nm]/Ta [2 nm]/Ru [15 nm]

The functional layer 21 was formed in the same manner as described above. More specifically, IAO treatment for FeCo [1 nm]/Zn [0.6 nm] was repeated 30 times. The oxygen exposure dose was 3.0×10⁴ L (Comparative Example 3), 1.2×10⁴ L (Example 8), 1.5×10⁴ L (Example 9), or 1.8×10⁴ L (Example 10). In this manner, four types of the magnetoresistive element 10 were manufactured.

The sheet resistance was measured for each functional layer 21. The RA value and the MR ratio were measured for each magnetoresistive element 10. These results are listed in Table 1, together with the oxygen exposure dose. Table 1 also lists the RA value and the MR ratio of the magnetoresistive element 10 of Comparative Example 2 which was manufactured in the same manner as in Example 8 to 10, except that no functional layer was provided.

TABLE 1

| | Oxygen | | | |
|---|---|---|---|---|
| | exposure | | | |
| | dose in | Sheet | | |
| | IAO | Resistance | RA Value | MR ratio |
| | (Langmuir) | (μΩcm) | (μΩm²) | (%) |
| Comparative | — | — | 1.1 | 52 |
| Example 2 | | | | |
| Comparative | 3.0 × 10⁴ | 5.0 × 10⁴ | 1.7 | 47 |
| Example 3 | | | | |
| Example 8 | 1.2 × 10⁴ | 2.2 × 10³ | 1.1 | 56 |
| Example 9 | 1.5 × 10⁴ | 1.3 × 10⁴ | 1.1 | 63 |
| Example 10 | 1.8 × 10⁴ | 4.0 × 10⁴ | 1.3 | 62 |

The results in Table 1 indicate that the MR ratio was higher when the resistivity of the functional layer was less than 5×10⁴ μΩcm.

The reason for the above results is presumed to be as follows. That is, spin-flip was prevented in the functional layer 21 because the functional layer 21 having a low resistivity was formed using an adequate oxygen exposure dose.

### Second Embodiment

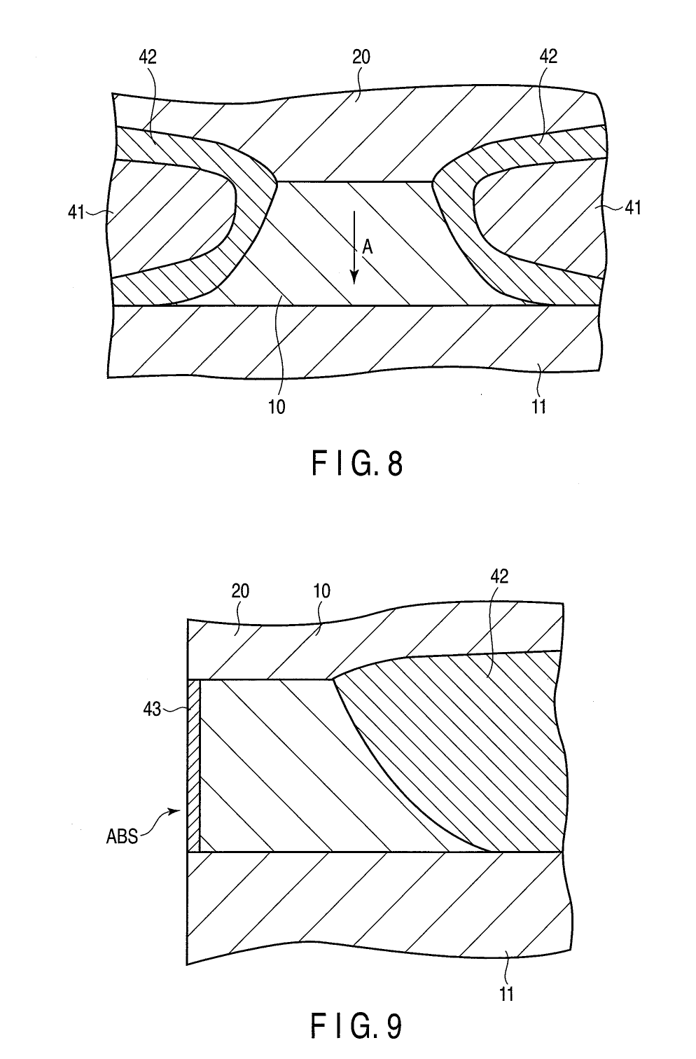

A magnetic head including the magnetoresistive element 10 according to the present embodiment is described below. FIGS. 8 and 9 show a magnetic head including the magnetoresistive element 10 according to the present embodiment. FIG. 8 is a cross-sectional view of the magnetoresistive element 10, cut almost parallel to an air bearing surface facing a magnetic recording medium (not shown). FIG. 9 is a cross-sectional view of the magnetoresistive element 10, cut perpendicular to the surface facing the medium.

The magnetic head shown in FIGS. 8 and 9 has a so-called hard abutted structure. The lower electrode 11 and the upper electrode 20 are provided under and over the magnetoresistive element 10, respectively. In FIG. 8, bias magnetic field application films 41 and insulating films 42 are stacked on the both sides of the magnetoresistive element 10. As shown in FIG. 9, a protective layer 43 is provided on the air bearing surface of the magnetoresistive element 10.

A sense current for the magnetoresistive element 10 is supplied by the lower electrode 11 and the upper electrode 20 perpendicularly to the plane as shown by arrow A, the electrodes 11 and 20 being arranged under and over the magnetoresistive element 10, respectively. Further, the pair of bias magnetic field application films 41, which are provided on the both sides of the magnetoresistive element 10, applies a bias magnetic field to the magnetoresistive element 10. The bias magnetic field controls the magnetic anisotropy of the free layer 18 in the magnetoresistive element 10 to make the free layer 18 into a single domain. This stabilizes the domain structure of the free layer. It is thus possible to suppress Barkhausen noise associated with movement of magnetic domain walls.

Since the S/N ratio of the magnetoresistive film is improved, the application of the magnetoresistive element 10 to a magnetic head enables sensitive magnetic reproduction.

### Third Embodiment

A magnetic recording apparatus and a magnetic head assembly including the magnetoresistive element 10 according to the present embodiment are described below.

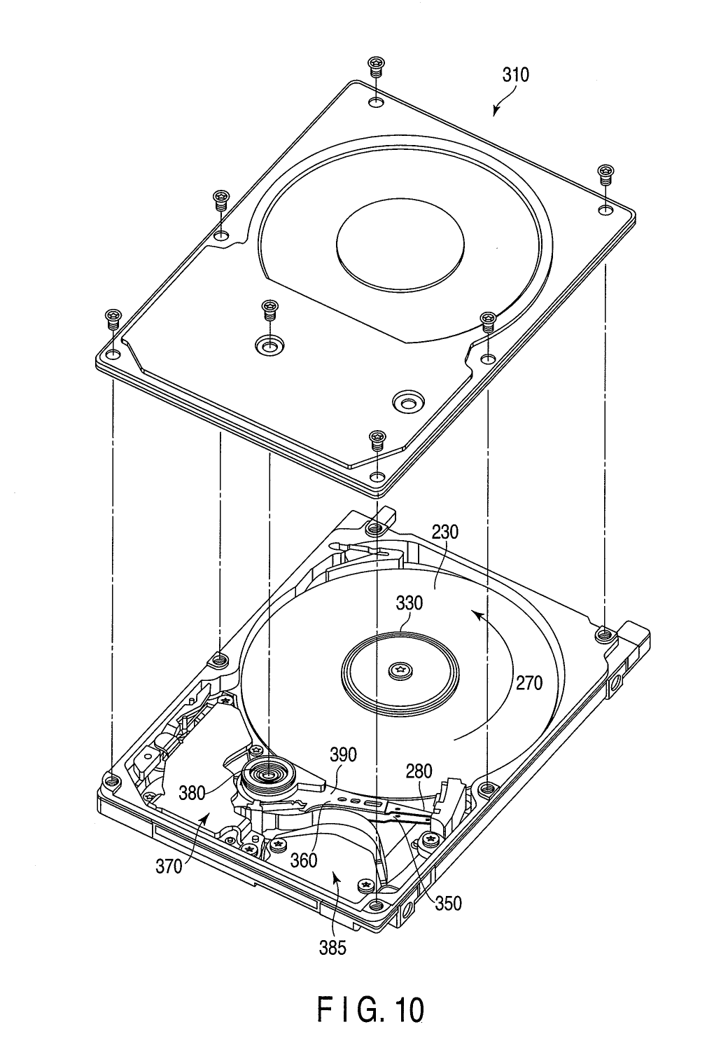

FIG. 10 is a perspective view of the magnetic recording apparatus according to the present embodiment.

As shown in FIG. 10, a magnetic recording apparatus 310 according to the present embodiment is of a type using a rotary actuator. A magnetic recording medium 230 is installed on a spindle 330 and rotated in a medium moving direction 270 by a motor (not shown) which responds to control signals from a drive controller (not shown). The magnetic recording apparatus 310 may include a plurality of magnetic recording mediums 230.

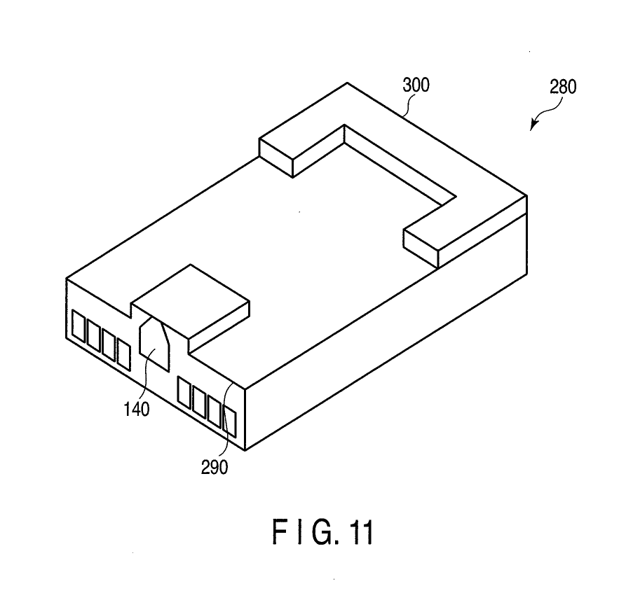

As shown in FIG. 11, a head slider 280 which records and reproduces the information on the magnetic recording medium 230 includes a magnetic head 140 provided with the magnetoresistive element 10. The head slider 280 is made of, for example, Al₂O₃/TiC, and configured to relatively move above the magnetic recording medium 230 such as a magnetic disk while floating thereover or in contact therewith.

The head slider 280 is attached to the tip of a thin film-shaped suspension 350. The magnetic head 140 is provided near the tip of the head slider 280.

When the magnetic recording medium 230 is rotated, the pressing pressure applied by the suspension 350 matches with the pressure developed on the air bearing surface of the head slider 280. The air bearing surface of the head slider 280 is kept away from the surface of the magnetic recording medium 230 at a predetermined floating height. The head slider 280 may be of “in-contact type” which contacts with the magnetic recording medium 230.

The suspension 350 is connected to one end of an actuator arm 360 which includes a bobbin part supporting a driving coil (not shown). A voice coil motor 370, which is a kind of linear motor, is provided at the other end of the actuator arm 360. The voice coil motor 370 may include a magnetic circuit including the driving coil (not shown), which is wound around the bobbin part of the actuator arm 360, and a permanent magnet and a counter yoke which are provided to face each other so as to sandwich the driving coil.

The actuator arm 360 is held by ball bearings (not shown) provided at the top and bottom of a pivot 380, and is configured to be swingably slid by the voice coil motor 370. This allows free moving of the magnetic head 140 to any position on the magnetic recording medium 230.

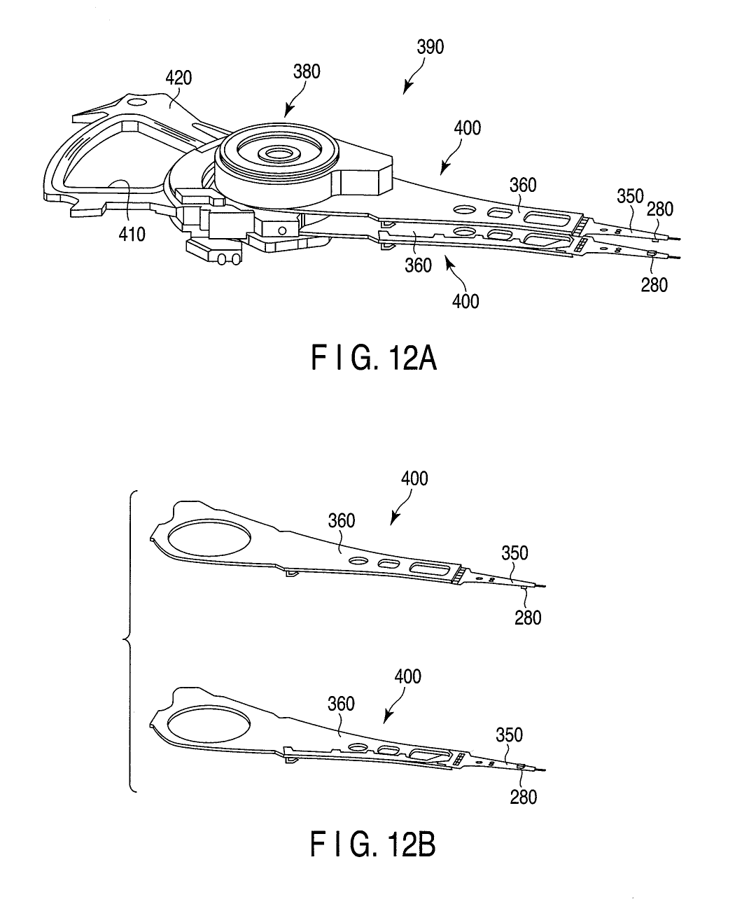

FIG. 12A shows a head stack assembly 390 as a portion of the magnetic recording apparatus 310 according to the present embodiment.

FIG. 12B is a perspective view showing a magnetic head assembly (head gimbal assembly [HGA]) 400 as a portion of the head stack assembly 390.

As shown in FIG. 12A, the head stack assembly 390 includes the pivot 380, a head gimbal assembly 400 extending from the pivot 380, and a support frame 420 which extends from the pivot 380 in a direction opposite to the head gimbal assembly 400 and supports a coil 410 of the voice coil motor.

As shown in FIG. 12B, the head gimbal assembly 400 includes the actuator arm 360 extending from the pivot 380, and the suspension 350 extending from the actuator arm 360.

The head slider 280 including a magnetic recording head 140, which has been described in the second embodiment, is provided at the tip of the suspension 350.

The magnetic head assembly (head gimbal assembly [HGA]) 400 according to the present embodiment includes the magnetic recording head 140 described in the second embodiment, the head slider 280 including the magnetic recording head 140, the suspension 350 equipped with the head slider 280 at one end thereof, and the actuator arm 360 connected to the other end of the suspension 350.

The suspension 350 includes leads (not shown) for reading and writing signals, for heater for controlling the floating height, and for STO10. The leads are electrically connected to the electrodes of the magnetic recording head 140 included in the head slider 280. Electrode pads (not shown) are provided in the head gimbal assembly 400. In the present embodiment, eight electrode pads are provided; two electrode pads for the coil of a main magnetic pole 200, two electrode pads for a magnetic reproducing element 190, two electrode pads for dynamic flying height (DFH), and two electrode pads for STO10.

A signal processor 385 (not shown) is provided on the back of the magnetic recording apparatus 310 shown in FIG. 10. The signal processor 385 reads and writes signals to the magnetic recording medium 230 using the magnetic recording head 140. The input and output lines of the signal processor 385 are connected to the electrode pads of the head gimbal assembly 400, and electrically coupled with the magnetic recording head 140.

The magnetic recording apparatus 310 according to the present embodiment includes the magnetic recording medium 230, the magnetic recording head 140, a moving unit which can move the opposing magnetic recording medium 230 and magnetic recording head 140 in a relative manner while keeping them away or in contact with each other, a position controller which places the magnetic recording head 140 to a predetermined recording position on the magnetic recording medium 230, and the signal processor 385 which reads and writes signals on the magnetic recording medium 230 using the magnetic recording head 140.

As the magnetic recording medium 230, the above-described magnetic recording medium 230 is used. The above-described moving unit may include the head slider 280. The above-described position controller may include the head gimbal assembly 400.

The magnetic recording apparatus 310 includes the magnetic recording medium 230, the head gimbal assembly 400, and the signal processor 385 which reads and writes signals on the magnetic recording medium 230 using the magnetic recording head 140 included in the head gimbal assembly 400.

Based on the above-described magnetic head and magnetic recording apparatus as the embodiments, any magnetoresistive elements, magnetic heads, magnetic recording apparatuses, and magnetic memories, which may be appropriately modified by those skilled in the art, may also includes the magnetoresistive element according to the above embodiment.

In the above embodiments, although the magnetoresistive element 10 of bottom type is described, the magnetoresistive element 10 of top type, in which the pinned layer 14 is formed above the spacer layer 16, will achieve the effect of the above embodiments.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetoresistive element comprising:
a stack comprising:
a cap layer;
a magnetization pinned layer comprising a lower pinned layer and an upper pinned layer;
a magnetization free layer, the magnetization free layer between the cap layer and the magnetization pinned layer;
a tunneling insulator between the magnetization pinned layer and the magnetization free layer, and
a functional layer comprising an oxide, the oxide including at least one element selected from the group consisting of Zn, In, Sn and Cd and at least one element selected from the group consisting of Fe, Co and Ni.

2. The magnetoresistive element of claim 1, wherein the functional layer is between the lower magnetization pinned layer and the tunneling insulator.

3. The magnetoresistive element of claim 1, wherein the functional layer is between the tunneling insulator and the magnetization free layer.

4. The magnetoresistive element of claim 1, wherein the functional layer is within the magnetization free layer.

5. The magnetoresistive element of claim 1, wherein the functional layer is between the magnetization free layer and the cap layer.

6. The magnetoresistive element of claim 1, further comprising a pair of electrodes configured to provide electric current through the stack in a direction perpendicular to a surface of the stack.

7. The magnetoresistive element of claim 1, wherein a resistivity of the functional layer is less than 5×10⁴ μΩ·cm.

8. The magnetoresistive element of claim 1, wherein a thickness of the functional layer is 1 nm or more and 10 nm or less.

9. The magnetoresistive element of claim 1, wherein the functional layer further comprises at least one element selected from the group consisting of Al, B, Ga, In, C, Si, Ge and Sn.

10. The magnetoresistive element of claim 1, wherein the tunneling insulator comprises a non-magnetic oxide, the oxide containing at least one element selected from the group consisting of Mg, Al, Ti, Zr, Hf and Zn.

11. A magnetic recording apparatus comprising:
a magnetic recording medium;
a magnetic recording head comprising the magnetoresistive element of claims 1; and
a signal processor configured to read from and to write to the magnetic recording medium using the magnetic recording head.
